(19) United States
(12) Patent Application Publication
(10) Pub. No.: US 2025/0313278 A1
(43) Pub. Date: Oct. 9, 2025

(54) CONNECTION ADAPTER FOR FASTENING A CHASSIS COMPONENT

(71) Applicant: Benteler Automobiltechnik GmbH, Paderborn (DE)

(72) Inventors: Christoph SCHWEGMANN, Doerentrup (DE); Dietmar HOFFMANN, Paderborn (DE); Peter Michael STASTNY, Delbrueck (DE)

(21) Appl. No.: 19/169,849

(22) Filed: Apr. 3, 2025

(30) Foreign Application Priority Data
Apr. 8, 2024 (EP) 24169068.4

(51) Int. Cl. B62D 27/06; B21D 22/20; B62D 21/02

(52) U.S. Cl. CPC B62D 27/06; B62D 21/02; B21D 22/20

(57) ABSTRACT

The disclosure relates to a connection adapter for fastening a chassis component at a vehicle component. The connection adapter may be formed as a hollow-cylindrical sleeve, which may have a cylinder cover surface and a cylinder lateral surface. The cylinder cover surface and the cylinder lateral surface may delimit a sleeve interior of the hollow-cylindrical sleeve. The cylinder lateral surface may be fastenable at the chassis component in a material-bonding manner and/or in a force-fitting manner and/or in a form-fitting manner. A fastening opening may be formed in the cylinder cover surface, through which a fastening means may be guidable in order to fasten the connection adapter at the vehicle component. The hollow cylindrical sleeve may be formed as a one-piece and material-uniform deep-drawn component made of steel.

### CROSS REFERENCE

The present application claims the benefit of European Patent Application No. 24169068.4 by Schwegmann et al., entitled “ANBINDUNGSADAPTER ZUR BEFESTIGUNG EINES FAHRWERKBAUTEILS”, filed Apr. 8, 2024, which is assigned to the assignee hereof and is incorporated herein by reference in its entirety.

### TECHNICAL FIELD

The present disclosure relates to a connection adapter for fastening a chassis component, in particular a connection adapter for fastening a chassis component at a vehicle component, a chassis arrangement in a vehicle comprising a chassis component and a connection adapter, and a method for producing a connection adapter.

### BACKGROUND

Chassis components such as axle supports are installed in vehicles to achieve a stable connection between vehicle components such as the vehicle body and the chassis. A high level of structural stability of the connection adapter is required to provide the structural connection between a chassis component and the vehicle component, so there is a need to provide connection adapters which, in addition to having a correspondingly high level of structural stability, can also be manufactured easily and inexpensively.

Conventional connection adapters manufactured using the cold pressing method have unnecessarily high wall thicknesses in the area of the connection to the vehicle body, which has a negative impact on the component weight and material costs.

In DE 10 2021 003 727 A1, a subframe with receiving bushings for arrangement in a bodyshell of a motor vehicle is disclosed, wherein a substitute is accommodated in each receiving bushing.

### SUMMARY

It is the object of the present disclosure to provide a connection adapter for connecting a chassis component at a vehicle component, wherein the connection adapter can be produced cost-effectively and has a high structural stability.

This object is achieved by the features of the independent claims. Advantageous examples of the disclosure are the subject of the dependent claims, the description and the accompanying figures.

The present disclosure is based on the finding that the above object can be achieved by a connection adapter made of steel and formed as a one-piece and material-uniform deep-drawn component in order to ensure the required structural stability of the deep-drawn connection adapter.

According to a first aspect, the disclosure relates to a connection adapter for fastening a chassis component at a vehicle component, wherein the connection adapter is formed as a hollow cylindrical sleeve, which has a cylinder cover surface and a cylinder lateral surface, wherein the cylinder cover surface and the cylinder lateral surface delimit a sleeve interior of the hollow cylindrical sleeve, wherein the cylinder lateral surface is fastenable at the chassis component in a material-bonding manner and/or in a force-fitting manner and/or in a form-fitting manner, wherein a fastening opening is formed in the cylinder cover surface, through which a fastening means is guidable in order to fasten the connection adapter at the vehicle component, and wherein the hollow cylindrical sleeve is formed as a one-piece and material-uniform deep-drawn component made of steel.

This achieves the technical advantage that the one-piece and material-uniform deep-drawn sleeve made of steel can be produced simply and effectively by means of a deep-drawing method and has the required wall thickness, which is necessary to provide the required structural stability for the connection between the chassis component and the vehicle component.

The corresponding deep-drawing method for producing the hollow cylindrical sleeve made of steel allows a large number of connection adapters to be produced easily and cost-effectively in a short time. In addition, the identically manufactured connection adapters can be arranged at different positions of different chassis components, such as in particular axle supports, in order to provide an effective connection between the chassis component and the vehicle component at different positions. This reduces the manufacturing and assembly effort, and a significant cost reduction can be achieved.

The connection adapter, which is formed as a hollow cylindrical sleeve, has a cylinder lateral surface to which the chassis component is fastenable in a material-bonding manner, in particular welded, and/or in a force-fitting manner, in particular screwed, and/or in a form-fitting manner, in particular crimped. In this case, there may be one weld seam or there may be several weld seams which run around the cylinder lateral surface partially or completely.

The connection adapter, which is formed as a hollow cylindrical sleeve, has a cylinder cover surface with a fastening opening through which a fastening means, in particular a fastening screw, is guidable in order to fasten the connection adapter at the vehicle component, in particular a vehicle floor of the vehicle.

The fastening opening can be formed in particular as a circular, oval or slot-shaped fastening opening in the cylinder cover surface. The fastening opening can be formed in particular centrally in the cylinder cover surface, in particular at a center point of the cylinder cover surface.

Thus, the geometry of the hollow cylindrical sleeve allows a uniform introduction of force from the chassis component through the cylinder lateral surface and through the cylinder cover surface at the vehicle component, or in an opposite direction.

The chassis component is in particular a front axle carrier, a rear axle carrier, or a twist beam axle, which in particular comprises a longitudinal member and/or cross member.

The vehicle component is formed in particular as a vehicle body component, in particular as a vehicle floor.

In an advantageous example, the cylinder cover surface and/or the cylinder lateral surface of the hollow cylindrical sleeve have a wall thickness between 1.5 mm and 5 mm, preferably between 2 mm and 4 mm.

This provides the technical advantage that the corresponding wall thicknesses ensure sufficient structural stability of the connection adapter.

In particular, the cylinder cover surface and the cylinder lateral surface of the hollow cylindrical sleeve have a wall thickness between 1.5 mm and 5 mm, preferably between 2 mm and 4 mm.

In an advantageous example, the hollow-cylindrical sleeve has a transition region circumferring the sleeve, which transition region is formed between the cylinder cover surface and the cylinder lateral surface of the hollow-cylindrical sleeve, wherein the transition region circumferring the sleeve is formed in particular as a rounded edge of the cylinder cover surface.

This achieves the technical advantage that the corresponding circumferring transition region, in particular the rounded edge of the cylinder cover surface, enables a structurally stable connection between the cylinder lateral surface and the cylinder cover surface.

In an advantageous example, the circumferring transition region, in particular the rounded edge of the cylinder cover surface, has a wall thickness between 1.0 mm and 5 mm.

This achieves the technical advantage that the corresponding circumferring transition region, in particular the rounded edge of the cylinder cover surface, has a minimally reduced wall thickness compared to the cylinder cover surface and/or the cylinder lateral surface due to the manufacturing method using the deep-drawing method, which wall thickness, however, is still sufficient in the range between 1.0 mm and 5 mm to achieve sufficient structural stability of the connection adapter.

In an advantageous example, the hollow cylindrical sleeve has no cylinder bottom surface at a bottom side of the hollow cylindrical sleeve opposite the cylinder cover surface.

This achieves the technical advantage that the weight of the connection adapter can be advantageously reduced by a corresponding open bottom side of the hollow cylindrical sleeve, while the overall structural stability of the connection adapter is still ensured due to the force introduction via the cylinder lateral surface.

In an advantageous example, the hollow cylindrical sleeve has an outer diameter between 30 mm and 150 mm, preferably between 40 mm and 80 mm, and/or the hollow cylindrical sleeve has a height between 30 mm and 200 mm, and/or the fastening opening in the cylinder cover surface has an opening diameter between 7 mm and 30 mm.

This achieves the technical advantage that the corresponding dimensions of the hollow cylindrical sleeve enable the connection adapter to be used effectively at the connection point between the chassis component and the vehicle component, or that the opening diameter of the fastening opening is sufficient to ensure effective passage of the fastening means.

In an advantageous example, the cylinder lateral surface is weldable and/or screwable to the chassis component.

This achieves the technical advantage that welding the cylinder lateral surface of the connection adapter to the chassis component achieves a particularly effective fastening. In particular, the cylinder lateral surface can be welded directly to a longitudinal member and/or cross member of the chassis component, or the cylinder lateral surface can be welded to an adapter arm of the chassis component, in which case the adapter arm is weldable and/or screwable directly to the longitudinal member and/or cross member of the chassis component.

According to a second aspect, the disclosure relates to a chassis arrangement in a vehicle, comprising a chassis component, and at least one connection adapter according to the first aspect, wherein the cylinder lateral surface of the at least one connection adapter is fastened to the chassis component in a material-bonding manner, in particular welded, and/or in a force-fitting manner, in particular screwed, and/or in a form-fitting manner, in particular crimped.

This achieves the technical advantage that the geometry of the at least one connection adapter within the chassis arrangement enables an effective material-bonding fastening between the chassis component and the at least one connection adapter.

In particular, the at least one connection adapter comprises a single connection adapter or a plurality of connection adapters, in particular two, three, four, five, six, seven, eight, nine or ten connection adapters, which are fastened to the chassis component.

In particular, the chassis component is made of a metal, in particular aluminum and/or steel, or a fiber-reinforced plastic.

In particular, the chassis component has a hollow profile.

In an advantageous example, the chassis component is a front axle carrier, a rear axle carrier, or a twist beam axle, which in particular comprises a longitudinal member and/or a cross member.

This provides the technical advantage that an effective connection with the aforementioned chassis components can be achieved through the connection adapter.

In an advantageous example, the at least one connection adapter is fastened to the chassis component, in particular the longitudinal member and/or cross member of the chassis component, in a material-bonding manner and/or in a force-fitting manner and/or in a form-fitting manner, wherein the at least one connection adapter is fastened in particular in a material-bonding manner and/or in a force-fitting manner and/or in a form-fitting manner to an adapter arm of the chassis component, wherein the adapter arm is connected in particular in a material-bonding manner, in particular welded, and/or in a force-fitting manner, in particular screwed, to the longitudinal member and/or the cross member.

This achieves the technical advantage that, depending on the component geometry of the chassis component and the vehicle component, the at least one connection adapter is either fastenable directly to the longitudinal member and/or cross member, and/or that the at least one connection adapter is fastenable to the longitudinal member and/or cross member at a distance by the adapter arm.

In particular, the at least one connection adapter comprises a plurality of connection adapters, wherein at least one of the connection adapters is fastened directly to the longitudinal member and/or cross member of the chassis component in a material-bonding manner and/or in a force-fitting manner and/or in a form-fitting manner, and wherein at least one of the connection adapters is fastened to the longitudinal member and/or cross member at a distance by the adapter arm of the chassis component, in particular in a material-bonding manner, in particular welded, and/or in a force-fitting manner, in particular screwed.

In particular, the adapter arm has two arm flanges at a first arm section facing the connection adapter, which arm flanges rest at the cylinder lateral surface of the hollow cylindrical sleeve of the connection adapter and are connected to the cylinder lateral surface in a material-bonding manner, in particular welded, and/or in a force-fitting manner, in particular screwed, and/or in a form-fitting manner, in particular crimped. In particular, the first arm section extends horizontally.

In particular, the adapter arm has a second arm section facing away from the connection adapter or the first arm section, wherein a second arm section end of the second arm section is connected to the longitudinal member and/or cross member in a material-bonding manner, in particular welded, and/or in a force-fitting manner, in particular screwed. In particular, the second arm section extends obliquely vertically.

In particular, the adapter arm has a third curved arm section, which connects the first, in particular horizontal arm section, with the second, in particular obliquely vertical, arm section.

In particular, the adapter arm has an adapter arm base body, which extends along the first, second and third arm sections, wherein the two arm flanges are in particular part of the adapter arm base body.

In particular, the adapter arm has an adapter arm cover plate, which is connected to the adapter arm base body in a material-bonding manner and which covers an open upper side of the adapter arm base body and extends in particular along the first, second and third arm sections. In particular, a cover plate end of the adapter arm cover plate facing the connection adapter rests at the cylinder lateral surface of the connection adapter and is connected to it in a material-bonding manner, in particular welded. The cover plate end in particular has a round recess, which rests at the cylinder lateral surface of the connection adapter.

In an advantageous example, the chassis arrangement has at least one end-side connection adapter, which is fastened, in particular directly fastened, to one end of the chassis component, in particular longitudinal member and/or cross member of the chassis component, and/or to a further end of the chassis component facing away from the end, in particular longitudinal member and/or cross member of the chassis component, in a material-bonding manner and/or in a force-fitting manner and/or in a form-fitting manner.

This achieves the technical advantage that a corresponding one-sided and/or two-sided end fastening of the connection adapter enables an effective structural connection.

In particular, a cylinder wall bottom side of the at least one end-side connection adapter is connected to the bottom side of the chassis component, in particular longitudinal member and/or cross member, in particular in a material-bonding manner.

In particular, a top opening of the chassis component, in particular the longitudinal member and/or cross member of the chassis component, is formed in the top side of the chassis component, in particular the longitudinal member and/or cross member of the chassis component, through which the at least one end-side connection adapter extends. In particular, an opening edge delimiting the top opening is connected in a material-bonding manner, in particular welded, to the cylinder lateral surface of the at least one end-side connection adapter. In particular, the at least one end-side connection adapter extends beyond the top side of the chassis component, in particular the longitudinal member and/or cross member of the chassis component.

In particular, the at least one end-side connection adapter is arranged at least partially within the chassis component, in particular longitudinal member and/or cross member of the chassis component.

In an advantageous example, the chassis arrangement has at least one central connection adapter, which is fastened to a central region of the chassis component, in particular longitudinal member and/or cross member of the chassis component, in a material-bonding manner and/or in a force-fitting manner and/or in a form-fitting manner, wherein the central region is arranged between one end of the chassis component, in particular longitudinal member and/or cross member of the chassis component, and a further end of the chassis component, in particular longitudinal member and/or cross member of the chassis component, facing away from the end, wherein in particular the central connection adapter is fastened to an adapter arm of the chassis component extending from the central region of the longitudinal member and/or cross member of the chassis component in a material-bonding manner and/or in a force-fitting manner and/or in a form-fitting manner, wherein the adapter arm is fastened in a material-bonding manner, in particular welded, and/or in a force-fitting manner, in particular screwed to the central region of the longitudinal member of the longitudinal and/or cross member.

This achieves the technical advantage that the central connection adapter enables a spaced-apart fastening to a section of the vehicle component that is at a distance from the longitudinal member and/or cross member by the adapter arm.

In an advantageous example, the chassis arrangement has a first longitudinal member and a second longitudinal member, wherein the chassis arrangement has a first and second cross member extending transversely to the first and second longitudinal members, wherein the first and second cross members are each fastened in a material-bonding manner and/or force-locked manner to the first longitudinal member and to the second longitudinal member.

This provides the technical advantage that a stable chassis arrangement is achieved by the corresponding two longitudinal members and the two cross members.

The design of the second longitudinal member corresponds to the design of the first longitudinal member.

In particular, the first and second cross members are made of a metal, in particular aluminum and/or steel, or a fiber-reinforced plastic. In particular, the first and second cross members have a hollow profile.

In particular, the first and second longitudinal members and/or the first and second cross members are formed as a tubular molded part, or the first and second longitudinal members and/or the first and second cross members are formed from a formed sheet metal, which is in particular part of a welded assembly.

The first and second longitudinal members are in particular formed as a curved longitudinal member. With respect to a central axis, which is arranged in the middle between the first and second longitudinal members and which extends transversely to the cross member, the first longitudinal member and the second longitudinal member are in particular arranged substantially mirror-symmetrically.

In an advantageous example, the chassis arrangement comprises a vehicle component, in particular a vehicle floor, and a fastening means, wherein the fastening means is guided through the fastening opening in the cylinder cover surface of the connection adapter and a further fastening opening of the vehicle component and is fixed to the connection adapter in order to fasten the chassis component, in particular longitudinal member and/or cross member, at the vehicle component.

This achieves the technical advantage that the vehicle component, in particular the vehicle floor, can be advantageously fastened to the chassis component, in particular the longitudinal member and/or cross member, by the connection adapter.

In particular, the fastening means, in particular fastening screw, has a stop, which rests at the edge of the opening delimiting the fastening opening and is fixed via a nut by means of the fastening shaft of the fastening means.

In particular, a washer or friction-increasing elements can be positioned between the fastening means, in particular the fastening screw, and the hollow cylindrical sleeve.

According to a third aspect, the disclosure relates to a method for producing a connection adapter for fastening a chassis component, in particular longitudinal member and/or cross member of the chassis component, at a vehicle component, wherein the method comprises the following method steps: providing a semi-finished product made of steel; deep-drawing the semi-finished product made of steel in order to obtain a cylindrical region with a cylinder cover surface and a cylinder lateral surface; introducing a fastening opening into the cylinder cover surface in order to obtain the connection adapter formed as a hollow cylindrical sleeve, which has the cylinder cover surface and the cylinder lateral surface, wherein the cylinder cover surface and the cylinder lateral surface delimit a sleeve interior of the hollow cylindrical sleeve, wherein the hollow cylindrical sleeve is formed as a one-piece and material-uniform deep-drawn component made of steel; and optionally separating the projection extending from the cylinder lateral surface of the connection adapter formed as a hollow cylindrical sleeve.

This provides the technical advantage of enabling a simple production of the connection adapter using a deep-drawing method, while at the same time ensuring sufficient structural stability of the hollow cylindrical sleeve.

In particular, a pre-hole can be made in the steel semi-finished product before the deep-drawing method step, whereby the pre-hole determines the position of the fastening opening for the subsequent method step of introducing the fastening opening into the cylinder cover surface.

In particular, instead of optionally separating the projection extending from the cylinder lateral surface of the connection adapter formed as a hollow cylindrical sleeve, it is also possible to optionally bend the projection extending from the cylinder lateral surface of the connection adapter formed as a hollow cylindrical sleeve so that the projection becomes part of the cylinder lateral surface of the connection adapter formed as a hollow cylindrical sleeve.

### BRIEF DESCRIPTION OF THE DRAWINGS

Further examples are explained with reference to the accompanying figures. It is shown in:

FIG. 1 shows a connection adapter for fastening a chassis component, in particular longitudinal member and/or cross member of the chassis component, at a vehicle component according to an example in a sectional view;

FIGS. 2A, 2B show an adapter arm of a chassis arrangement according to an example connected to the connection adapter of FIG. 1 in a side view and in a sectional view, respectively;

FIG. 3 shows a chassis arrangement with two connection adapters, each connected to an adapter arm according to FIGS. 2A and 2B and with four connection adapters according to FIG. 1 according to an example in a side view;

FIGS. 4A, 4B show the chassis arrangement shown in FIG. 3 comprising a vehicle component fastened by a fastening means to the chassis component, in particular longitudinal member and/or cross member of the chassis component, according to an example in a side view and in a sectional view, respectively; and

FIG. 5 shows a method for producing a connection adapter for fastening a chassis component, in particular longitudinal member and/or cross member of the chassis component, at a vehicle component.

### DETAILED DESCRIPTION

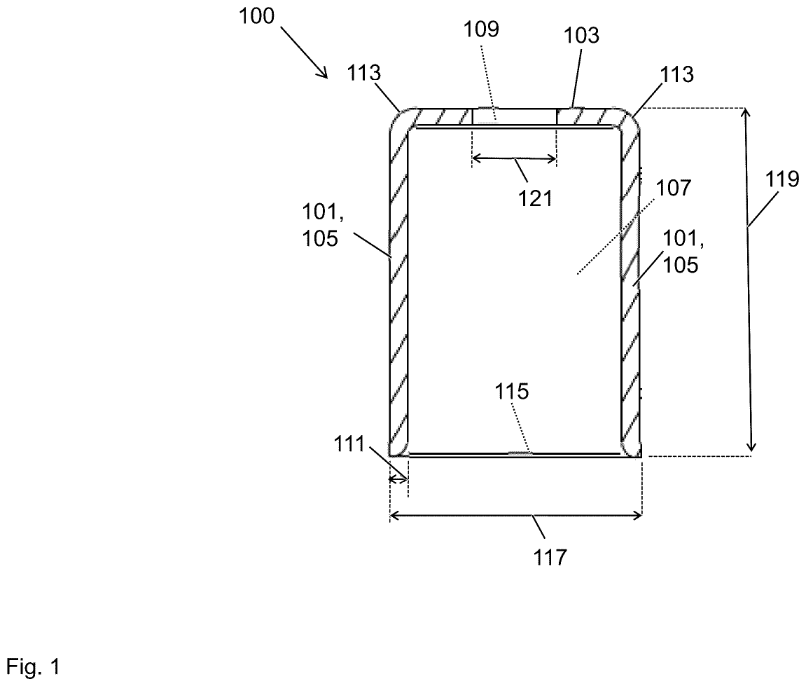

FIG. 1 shows a connection adapter for fastening a chassis component, in particular longitudinal member and/or cross member of the chassis component, at a vehicle component according to a first example in a sectional view.

The connection adapter 100 shown in FIG. 1 enables an effective, mechanically stable connection between the chassis component not shown in FIG. 1, in particular the longitudinal member and/or cross member of the chassis component, and the vehicle component also not shown in FIG. 1. For further details regarding the chassis component, in particular the longitudinal member and/or cross member of the chassis component, and the vehicle component, reference is made to the following explanations of the other figures.

The connection adapter 100 shown in FIG. 1 is formed as a hollow cylindrical sleeve 101, which has a cylinder cover surface 103 and a cylinder lateral surface 105. The cylinder cover surface 103 and the cylinder lateral surface 105 delimit a sleeve interior 107 of the hollow cylindrical sleeve 101.

From FIG. 1 it can be seen that a fastening opening 109 is formed in the cylinder cover surface 103 of the hollow cylindrical sleeve 101, through which a fastening means not shown in FIG. 1, in particular a fastening screw, is guidable in order to fasten the connection adapter 100 at the vehicle component not shown in FIG. 1.

The fastening opening 109 can be formed in particular as a circular, oval or slot-shaped fastening opening 109 in the cylinder cover surface 103. The fastening opening 109 can be formed in particular centrally in the cylinder cover surface 103, in particular at a center point of the cylinder cover surface 103.

Furthermore, the cylinder lateral surface 105 of the hollow cylindrical sleeve 101 is fastenable to the chassis component not shown in FIG. 1, in particular the longitudinal member and/or cross member, in a material-bonding manner and/or in a force-fitting manner and/or in a form-fitting manner.

The present disclosure is characterized in that the hollow cylindrical sleeve 101 made of steel is formed as a one-piece and material-uniform deep-drawn component, i.e. is manufactured by means of a deep-drawing method. The hollow cylindrical sleeve 101 manufactured by means of the deep-drawing method enables a particularly simple manufacture of the connection adapter 100, wherein the deep-drawn sleeve 101 in particular has a wall thickness 111 between 1.5 mm and 5 mm, preferably between 2 mm and 4 mm, which provides sufficient structural stability in order to be able to advantageously absorb forces acting between the vehicle component and the chassis component, in particular longitudinal member and/or cross member.

From the example according to FIG. 1 it can be seen that the cylinder cover surface 103 and the cylinder lateral surface 105 of the hollow cylindrical sleeve 101 have the same wall thickness 111 between 1.5 mm and 5 mm, preferably between 2 mm and 4 mm.

As can be seen from FIG. 1, the hollow cylindrical sleeve 101 has a transition region 113, which surrounds the sleeve 101 and is formed between the cylinder cover surface 103 and the cylinder lateral surface 105 of the hollow cylindrical sleeve 101, wherein the transition region 113 circumferring the sleeve 101 is formed in particular as a rounded edge of the cylinder cover surface 103.

Due to manufacturing reasons, the circumferring transition region 113, in particular the rounded edge of the cylinder cover surface 103, can have a wall thickness 111 which is minimally, in particular less than 20%, less than the wall thickness 111 of the cylinder cover surface 103 and the cylinder lateral surface 105 of the hollow cylindrical sleeve 101. In particular, the circumferring transition region 113, in particular the rounded edge of the cylinder cover surface 103, has a wall thickness 111 between 1.0 mm and 5 mm.

It can also be seen from FIG. 1 that the hollow cylindrical sleeve 101 has no cylinder bottom surface at a bottom side 115 of the hollow cylindrical sleeve 101 opposite the cylinder cover surface 103, whereby the weight of the hollow cylindrical sleeve 101 can be reduced without restricting the structural stability of the hollow cylindrical sleeve 101.

The hollow cylindrical sleeve 101 has in particular an outer diameter 117 between 30 mm and 150 mm, preferably between 40 mm and 80 mm. The hollow cylindrical sleeve 101 has in particular a height 119 between 30 mm and 200 mm.

In particular, the fastening opening 109 in the cylinder cover surface 103 has an opening diameter 121 between 7 mm and 30 mm.

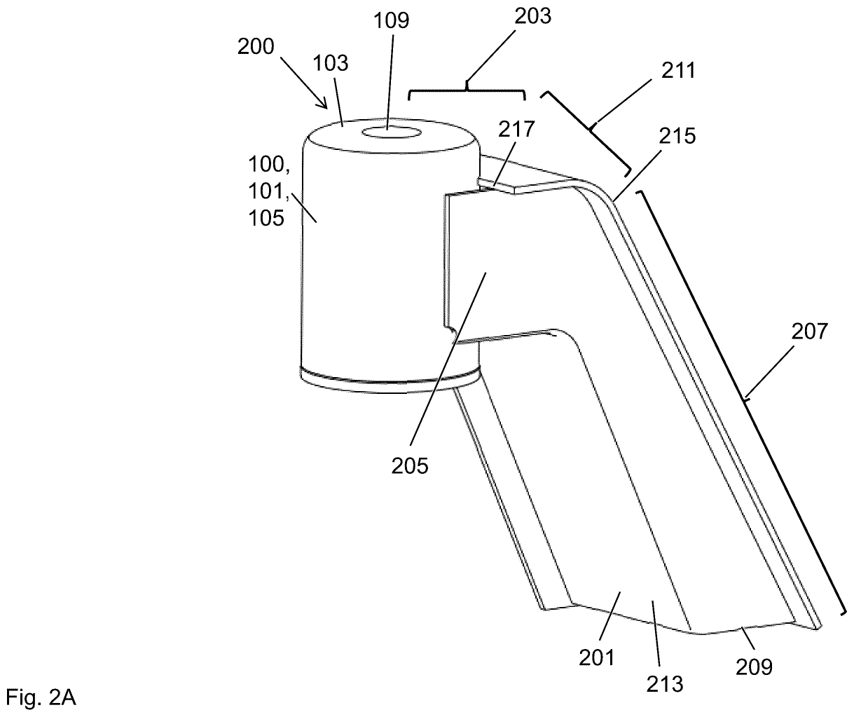

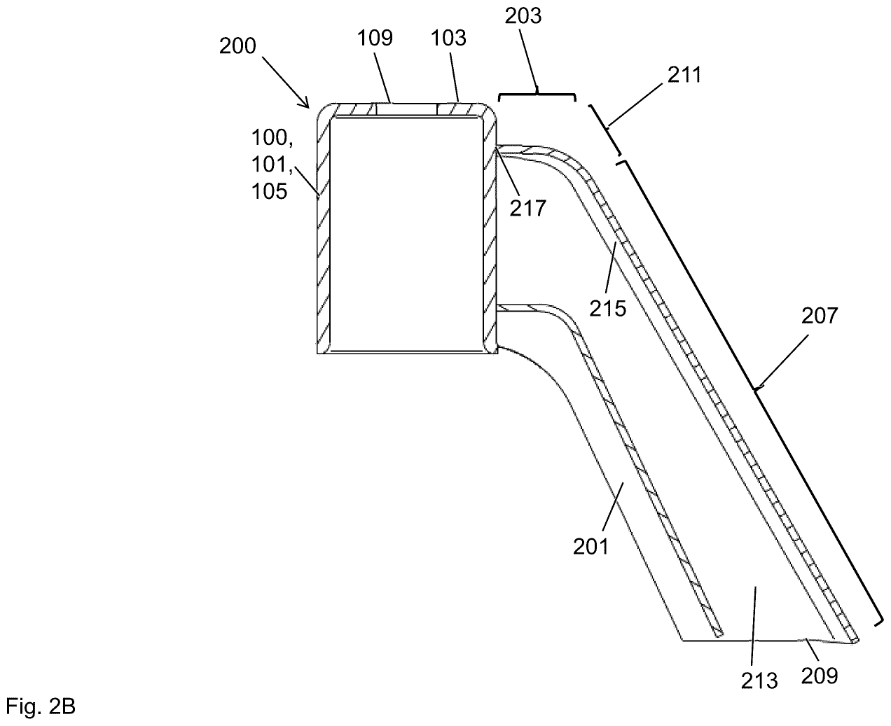

FIGS. 2A and 2B show an adapter arm of a chassis arrangement according to an example connected to the connection adapter of FIG. 1 in a side view and in a sectional view, respectively.

In particular, FIG. 2A shows the side view and FIG. 2B shows the sectional view.

In FIGS. 2A and 2B the adapter arm 201 of the chassis arrangement 200 is shown, whereby for further details regarding the chassis arrangement 200, reference is made to the following figures. The connection adapter 100 shown in FIGS. 2A and 2B corresponds to the connection adapter 100 shown in FIG. 1, so that for further details reference is made to the previous explanations of FIG. 1. The chassis component here comprises the adapter arm 201.

As can be seen from FIG. 2A or 2B, the connection adapter 100 is fastened to the adapter arm 201 in a material-bonding manner, whereby the adapter arm 201 is in particular welded to the connection adapter 100. Alternatively or additionally, a fastening in a force-fitting manner and/or in a form-fitting manner is also possible.

In particular, the adapter arm 201 has two arm flanges 205 at a first arm section 203 facing the connection adapter 100, which arm flanges 205 rest at the cylinder lateral surface 105 of the hollow cylindrical sleeve 101 of the connection adapter 100 and are connected in a material-bonding manner, in particular welded, to the cylinder lateral surface 105. Alternatively or additionally, a fastening in a force-fitting manner and/or in a form-fitting manner is also possible. As can be seen from FIG. 2A or 2B, the first arm section 203 extends horizontally.

In particular, the adapter arm 201 has a second arm section 207 facing away from the connection adapter 100 or the first arm section 203, wherein a second arm section end 209 of the second arm section 207 is connected in a material-bonding manner, in particular welded, and/or in a force-fitting manner, in particular screwed, to the longitudinal member and/or cross member of the chassis component (not shown in FIG. 2A, 2B). As can be seen from FIG. 2A, 2B, the second arm section 207 extends obliquely vertically.

In particular, the adapter arm 201 has a third curved arm section 211, which connects the first, in particular horizontal arm section 203, with the second, in particular obliquely vertical, arm section 207.

From FIGS. 2A and 2B it can also be seen that the adapter arm 201 has an adapter arm base body 213, which extends along the first, second and third arm sections 203, 207, 211, wherein the two arm flanges 205 are in particular part of the adapter arm base body 213.

From FIGS. 2A and 2B it can also be seen that the adapter arm 201 has an adapter arm cover plate 215, which is connected in a material-bonding manner to the adapter arm base body 213 and which covers an open upper side of the adapter arm base body 213 not shown in FIGS. 2A and 2B, and extends along the first, second and third arm sections 203, 207, 211. In particular, a cover plate end 217 of the adapter arm cover plate 215 facing the connection adapter 100 rests at the cylinder lateral surface 105 of the connection adapter 100 and is connected to it in a material-bonding manner, in particular welded. The cover plate end 217 in particular has a round recess, which rests at the cylinder lateral surface 105 of the connection adapter 100.

Even if this is not shown in FIG. 2A or 2B, the connection adapter 100 shown in FIG. 2A or 2B can also be fastened directly to the longitudinal member and/or cross member in a material-bonding manner and/or in a force-fitting manner without the adapter arm 201. Reference is made to the other figures for this purpose.

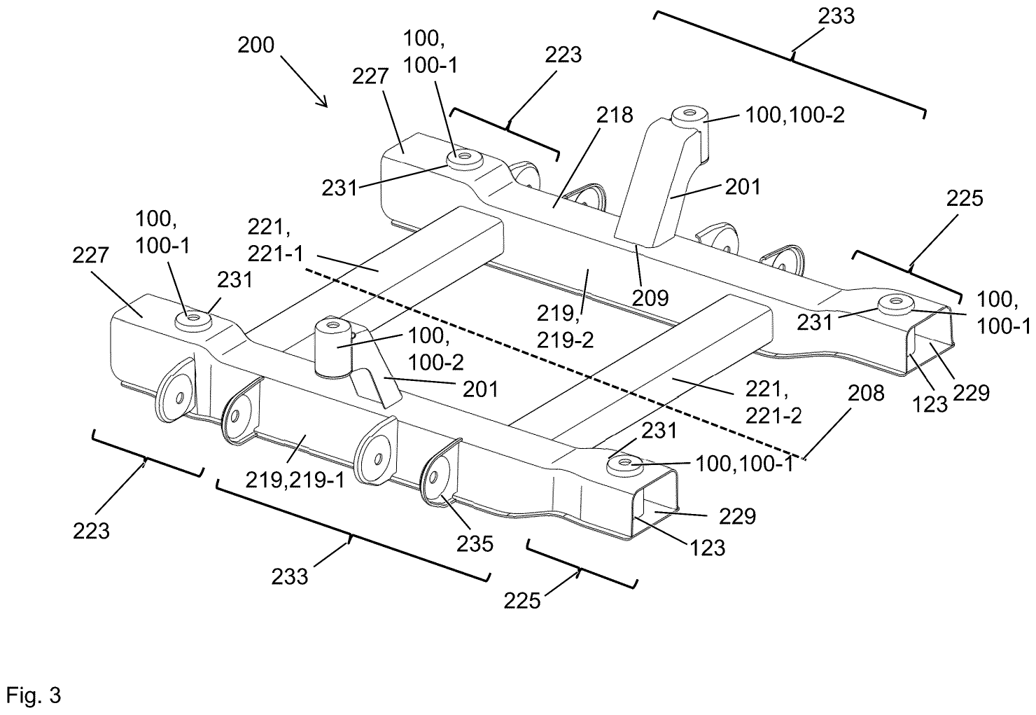

FIG. 3 shows a chassis arrangement with two connection adapters, each connected to an adapter arm according to FIGS. 2A and 2B and with four connection adapters according to FIG. 1 according to an example in a side view.

The chassis arrangement 200 comprises the chassis component 218 itself. The chassis component 218 comprises at least one longitudinal member 219, in particular a first longitudinal member 219-1 and a second longitudinal member 219-2, which extend next to one another. The chassis arrangement 200 comprises at least one cross member 221, in particular a first cross member 221-1 and a second cross member 221-2, which extend next to one another. The first and second cross members 221-1, 221-2 extend transversely to the first and second longitudinal members 219-1, 219-2. The first and second cross members 221-1, 221-2 are each fastened to the first longitudinal member 219-1 and to the second longitudinal member 219-2 in a material-bonding manner and/or in a force-fitting manner, in particular welded and/or screwed.

In the installed state of the chassis component 218, the longitudinal member 219-1 and the second longitudinal member 219-2 extend substantially along a direction of travel not shown in FIG. 3, and the first and second cross members 221-1, 221-2 extend substantially transversely to the direction of travel not shown.

The first longitudinal member 219-1 and the second longitudinal member 219-2 are formed as a formed sheet metal part, which is part of a welded assembly, and have a hollow profile. The first and second cross members 221-1, 221-2 can in particular also be formed as a formed sheet metal part, which is part of a welded assembly, and/or have a hollow profile. The cross members 221-1, 221-2 are in particular formed as straight cross members 221-1, 221-2. Alternatively, the longitudinal members 219-1, 219-2 and/or the cross members 221-1, 221-2 can also be formed as a tubular part, wherein such a tubular part can be produced by forming a plate with a U-shaped or O-shaped cross section.

The longitudinal members 219-1, 219-2 are in particular formed as curved longitudinal members 219-1, 219-2. With respect to a chassis component center axis 208, which is arranged in the middle between longitudinal members 219-1, 219-2 and which extends transversely to the cross members 221-1, 221-2, the first longitudinal member 219-1 and the second longitudinal member 219-2 are arranged essentially mirror-symmetrically.

In FIG. 3, four connection adapters 100 are shown, which are directly connected to the respective longitudinal members 219, 219-1, 219-2. These four connection adapters 100 are referred to below as end-side connection adapters 100-1. The end-side connection adapters 100-1 are arranged in a material-bonding manner, in particular welded, to ends 223 of the first or second longitudinal members 219-1, 219-2 or to further ends 225 of the first or second longitudinal members 219-1, 219-2 facing away from the ends 223. Alternatively or additionally, a fastening in a force-fitting manner and/or in a form-fitting manner is also possible.

As can be seen in FIG. 3, an end-side connection adapter 100-1 is arranged at one end 223 or further end 225 of the first or second longitudinal members 219-1, 219-2.

The end-side connection adapters 100-1 are in particular arranged at least partially within the respective longitudinal members 219-1, 219-2, as can be seen from FIG. 3.

In particular, a cylinder wall bottom side 123 of the respective end-side connection adapter 100-1 is connected to a respective bottom side 229 of the respective longitudinal members 219-1, 219-2, in particular connected in a material-bonding manner.

In particular, in the top side 227 of the respective longitudinal members 219-1, 219-2 a top opening 231 of the respective longitudinal members 219-1, 219-2 is formed, through which the respective end-side connection adapter 100-1 extends. In particular, an opening edge delimiting the respective top opening 231 and not marked in FIG. 3 is connected in a material-bonding manner, in particular welded, to the cylinder lateral surface 105 of the respective end-side connection adapter 100-1. In particular, the respective end-side connection adapter 100-1 extends beyond the respective top side 227 of the respective longitudinal members 219-1, 219-2.

In FIG. 3, two connection adapters 100 are shown, which are connected to the respective longitudinal members 219-1, 219-2 via the respective adapter arm 201. These two connection adapters 100 are referred to below as central connection adapters 100-2. The two central connection adapters 100-2 are each fastened to a central region 233 of the respective longitudinal members 219, 219-1, 219-2 by means of the respective adapter arm 201, wherein the respective central region 233, as shown in FIG. 3, extends between the respective end 223 and the respective further end 225 of the first or second longitudinal members 219-1, 219-2.

As already explained with reference to FIGS. 2A and 2B, a second arm section end 209 of the second arm section 207 of the respective adapter arm 201 is connected in a material-bonding manner, in particular welded, to the respective first or second longitudinal members 219-1, 219-2, in particular to the respective center region 233 of the respective longitudinal members 219, 219-1, 219-2. Alternatively or additionally, a fastening in a force-fitting manner is also possible.

Furthermore, a plurality of fastening sections 235 is arranged at the respective first and second longitudinal members 219-1, 219-2, which are adapted to fasten the chassis arrangement 200 to a further vehicle component, in particular the vehicle floor.

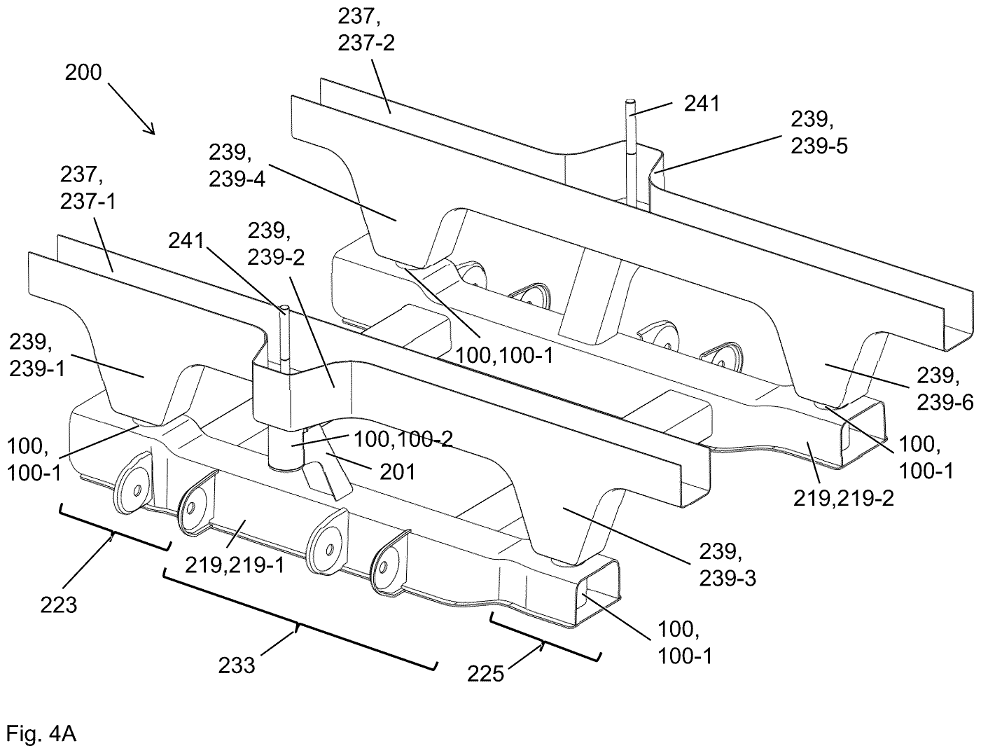

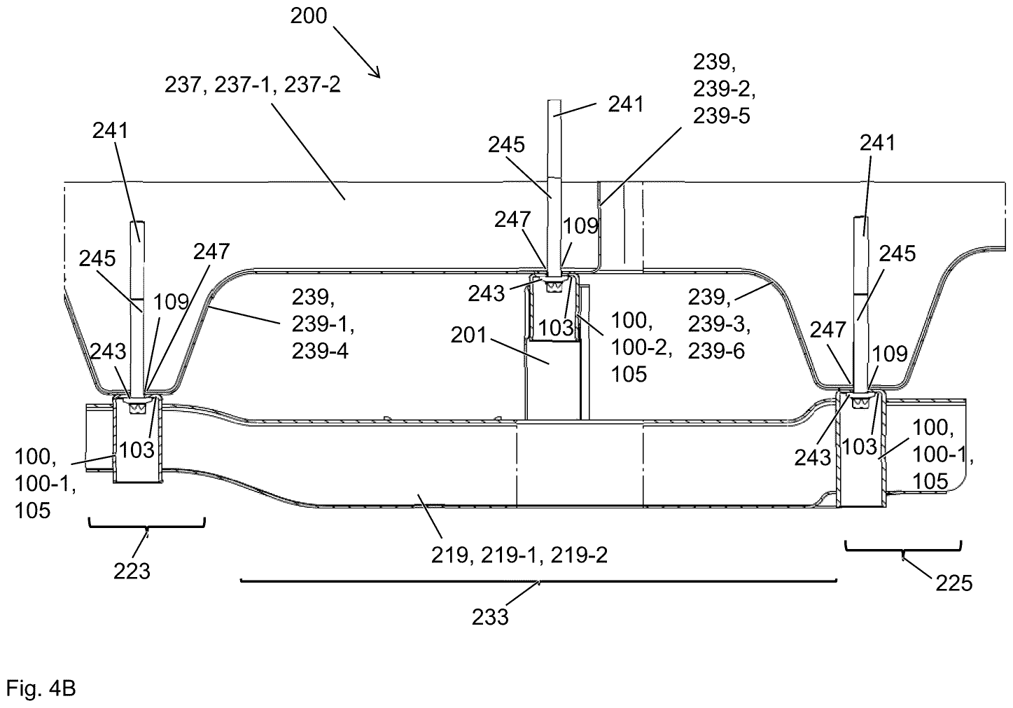

For the connection of the connection adapters 100, in particular the central connection adapter 100-2 and the end-side connection adapter 100-1, at the vehicle component, reference is made to the following FIG. 4A and FIG. 4B.

FIGS. 4A and 4B show the chassis arrangement 200 shown in FIG. 3 comprising a vehicle component fastened by a fastening means to the chassis component, in particular longitudinal member and/or cross member of the chassis component, according to an example in a side view and in a sectional view, respectively.

FIG. 4A shows the side view of the chassis arrangement 200, while FIG. 4B shows the sectional view through the chassis arrangement 200.

The chassis arrangement 200 shown in FIGS. 4A and 4B differs from the chassis arrangement 200 shown in FIG. 3 in that FIGS. 4A and 4B additionally show the vehicle component 237, which is fastened to the chassis component 218, in particular to the first and second longitudinal members 219, 219-1, 219-2, by fastening means 241 formed in particular as fastening screws.

The vehicle component 237 is formed in particular as a vehicle floor. Even if in FIGS. 4A and 4B the vehicle component 237, in particular the vehicle floor, is shown partially by a first vehicle component section 237-1 and by a second vehicle component section 237-2, the two sections 237-1, 237-2 are connected to one another by areas not shown in FIGS. 4A and 4B, wherein the vehicle component 237 is formed in particular as a multi-part component.

The vehicle component 237 has in particular a plurality of fastening projections 239, which are fastened by the respective fastening means 241 to the respective first or second longitudinal members 219-1, 219-2.

A first fastening projection 239-1 is in particular connected to the end-side connection adapter 100-1 arranged at the end 223 of the first longitudinal member 219-1 by a fastening means 241.

A second fastening projection 239-2 is in particular connected to the central connection adapter 100-2 arranged at the central region 233 of the first longitudinal member 219-1 by a fastening means 241.

A third fastening projection 239-3 is in particular connected to the end-side connection adapter 100-1 arranged at the further end 225 of the first longitudinal member 219-1 by a fastening means 241.

A fourth fastening projection 239-4 is in particular connected to the end-side connection adapter 100-1 arranged at the end 223 of the second longitudinal member 219-2 by a fastening means 241.

A fifth fastening projection 239-5 is in particular connected to the central connection adapter 100-2 arranged at the central region 233 of the second longitudinal member 219-2 by a fastening means 241.

A sixth fastening projection 239-6 is in particular connected to the end-side connection adapter 100-1 arranged at the further end 225 of the second longitudinal member 219-2 by a fastening means 241.

In the sectional view according to FIG. 4B, the connection of the vehicle component 237, in particular the vehicle floor, by means of the fastening means 241, in particular fastening screws, can be effectively recognized for the first and second longitudinal members 219-1, 219-2.

The respective fastening means 241, in particular fastening screw, is guided through the respective fastening opening 109 of the respective connection adapter 100, 100-1, 100-2, and has a respective stop 243, which rests at the respective opening edge delimiting the top opening 231 not marked in FIG. 4B, and is fixed respectively via a nut not shown in FIG. 4B by means of the respective fastening shaft.

The respective fastening means 241, in particular the fastening shaft 245, is guided through the respective fastening opening 109 in the cylinder cover surface 103 of the respective connection adapter 100 and a further fastening opening 247 of the vehicle component 237 (not shown in FIG. 4B), and is fixed to the connection adapter 100 in order to fasten the connection adapter 100 at the vehicle component 237.

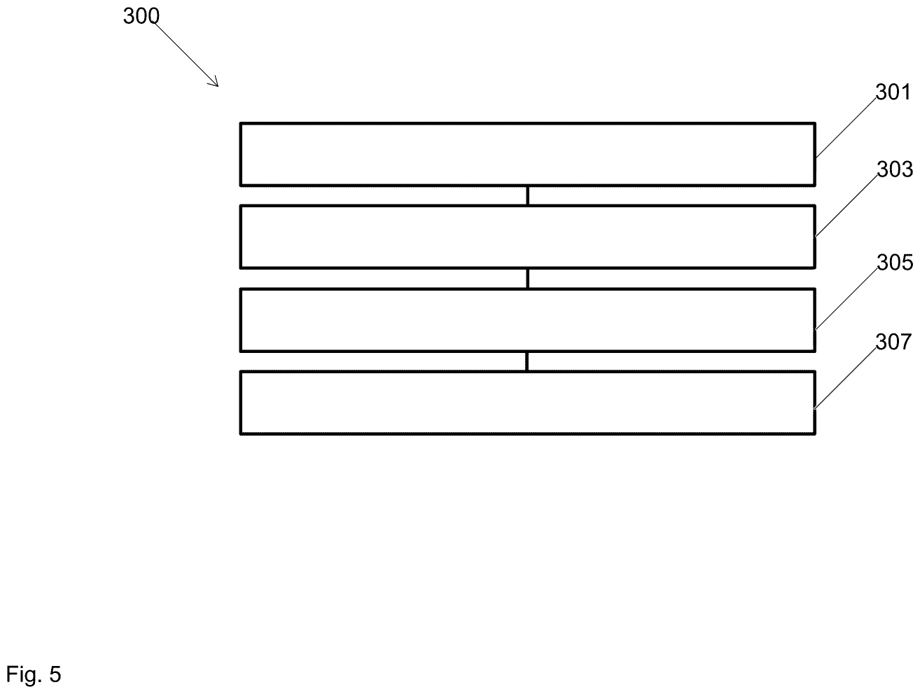

FIG. 5 shows a method for producing a connection adapter for fastening a chassis component, in particular longitudinal member and/or cross member of the chassis component, at a vehicle component.

The method 300 comprises, as a method step, the providing 301 of a semi-finished product made of steel.

The method 300 comprises, as a method step, the deep drawing 303 of the semi-finished product made of steel in order to obtain a hollow cylindrical region with a cylinder cover surface 103 and a cylinder lateral surface 105.

The method 300 comprises, as a method step, the introducing 305 of a fastening opening 109 into the cylinder cover surface 103 in order to obtain the connection adapter 100, 100-1, 100-2 formed as a hollow cylindrical sleeve 101, which connection adapter 100, 100-1, 100-2 has the cylinder cover surface 103 and the cylinder lateral surface 105, wherein the cylinder cover surface 103 and the cylinder lateral surface 105 delimit a sleeve interior 107 of the hollow cylindrical sleeve 101.

In particular, a pre-hole can be introduced in the steel semi-finished product before the method step of deep-drawing 303, wherein the pre-hole determines the position of the fastening opening 109 for the subsequent method step of introducing 305 the fastening opening 109 into the cylinder cover surface 103.

The method 300 comprises, as an optional method step, the separating 307 of the projection extending from the cylinder lateral surface 105 of the connection adapter formed as a hollow cylindrical sleeve.

In particular, instead of optionally separating the projection of the connection adapter 100 formed as a hollow cylindrical sleeve 101 extending from the cylinder lateral surface 105, the projection of the connection adapter 100 formed as a hollow cylindrical sleeve 101 extending from the cylinder lateral surface 105 can also optionally be bent so that the projection becomes part of the cylinder lateral surface 105 of the connection adapter 100 formed as a hollow cylindrical sleeve 101.

### REFERENCE NUMERALS

100 Connection adapter
100-1 End-side connection adapter
100-2 Central connection adapter
101 Hollow cylindrical sleeve
103 Cylinder cover surface
105 Cylinder lateral surface
107 Sleeve interior
109 Fastening opening
111 Wall thickness
113 Transition region
115 Bottom side of the hollow cylindrical sleeve
117 Outer diameter of the hollow cylindrical sleeve
119 Height of the hollow cylindrical sleeve
121 Opening diameter of the hollow cylindrical sleeve
123 Cylinder wall bottom side
200 Chassis arrangement
201 Adapter arm
203 First arm section
205 Arm flange
207 Second arm section
208 Center axis
209 Second arm section end
211 Third Arm Section
213 Adapter arm base body
215 Adapter arm cover plate
217 Cover plate end
218 Chassis component
219 Longitudinal member
219-1 First longitudinal member
219-2 Second longitudinal member
221 Cross member
221-1 First cross member
221-2 Second cross member
223 End of the first or second longitudinal member
225 Further end of the first or second longitudinal member
227 Top of the first or second longitudinal member
229 Bottom side of the first or second longitudinal member
231 Top opening of the first or second longitudinal member
233 Central region of the first or second longitudinal member
235 Fastening section
237 Vehicle component
237-1 First vehicle component section
237-2 Second vehicle component section
239 Fastening sections
239-1 First fastening section
239-2 Second fastening section
239-3 Third fastening section
239-4 Fourth fastening section
239-5 Fifth fastening section
239-6 Sixth fastening section
241 Fastening means
243 Stop
245 Fastening shaft
247 Further fastening opening of the vehicle component
300 Method for producing a connection adapter for fastening a chassis component, in particular longitudinal member and/or cross member of the chassis component, at a vehicle component
301 Method step: providing a semi-finished product made of steel
303 Method step: deep drawing the steel semi-finished product
305 Method step: introducing a fastening opening in the steel semi-finished product
307 Method step: separating the projection extending from the cylinder lateral surface

What is claimed is:

1. A connection adapter for fastening a chassis component at a vehicle component, wherein the connection adapter is formed as a hollow cylindrical sleeve, which has a cylinder cover surface and a cylinder lateral surface, wherein the cylinder cover surface and the cylinder lateral surface delimit a sleeve interior of the hollow cylindrical sleeve, and wherein:
the cylinder lateral surface is fastenable at the chassis component in a material-bonding manner, in a force-fitting manner, in a form-fitting manner, or any combination thereof,
a fastening opening is formed in the cylinder cover surface, through which a fastening means is guidable in order to fasten the connection adapter at the vehicle component, and
the hollow cylindrical sleeve is formed as a one-piece and material-uniform deep-drawn component made of steel.

2. The connection adapter according to claim 1, wherein the cylinder cover surface, the cylinder lateral surface, or both, of the hollow cylindrical sleeve have a wall thickness between 1.5 mm and 5 mm.

3. The connection adapter according to claim 1, wherein the hollow cylindrical sleeve has a transition region circumferring the hollow cylindrical sleeve, and wherein the transition region is formed between the cylinder cover surface and the cylinder lateral surface of the hollow cylindrical sleeve.

4. The connection adapter according to claim 3, wherein the transition region has a wall thickness between 1.0 mm and 5 mm.

5. The connection adapter according to claim 1, wherein the hollow cylindrical sleeve has no cylinder bottom surface at a bottom side of the hollow cylindrical sleeve opposite the cylinder cover surface.

6. The connection adapter according to claim 1, wherein the hollow cylindrical sleeve has an outer diameter between 30 mm and 150 mm, the hollow cylindrical sleeve has a height between 30 mm and 200 mm, the fastening opening in the cylinder cover surface has an opening diameter between 7 mm and 30 mm, or any combination thereof.

7. The connection adapter according to claim 1, wherein the cylinder lateral surface is weldable, screwable, or both, to the chassis component.

8. A chassis arrangement in a vehicle, comprising:
a chassis component, and
a connection adapter for fastening the chassis component at a vehicle component, wherein the connection adapter is formed as a hollow cylindrical sleeve, which has a cylinder cover surface and a cylinder lateral surface, wherein the cylinder cover surface and the cylinder lateral surface delimit a sleeve interior of the hollow cylindrical sleeve, and wherein:
the cylinder lateral surface is fastenable at the chassis component in a material-bonding manner, in a force-fitting manner, in a form-fitting manner, or any combination thereof,
a fastening opening is formed in the cylinder cover surface, through which a fastening means is guidable in order to fasten the connection adapter at the vehicle component, and
the hollow cylindrical sleeve is formed as a one-piece and material-uniform deep-drawn component made of steel,
wherein the cylinder lateral surface of the connection adapter is fastened to the chassis component in a material-bonding manner, in a force-fitting manner, in a form-fitting manner, or any combination thereof.

9. The chassis arrangement according to claim 8, wherein the chassis component is a front axle carrier, a rear axle carrier, or a twist beam axle.

10. The chassis arrangement according to claim 8, wherein the connection adapter is fastened to an adapter arm of the chassis component, in a material-bonding manner, in a force-fitting manner, in a form-fitting manner, or any combination thereof.

11. The chassis arrangement according to claim 8, wherein the chassis arrangement has at least one end-side connection adapter, which is fastened to one end of the chassis component or to a further end of the chassis component facing away from the one end of the chassis component.

12. The chassis arrangement according to claim 8, wherein the chassis arrangement has at least one central connection adapter, which is fastened to a central region of the chassis component in a material-bonding manner, in a force-fitting manner, in a form-fitting manner, or any combination thereof, and wherein the central region is arranged between one end of the chassis component, and a further end of the chassis component facing away from the one end of the chassis component.

13. The chassis arrangement according to claim 8, wherein the chassis arrangement has a first longitudinal member and a second longitudinal member, wherein the chassis arrangement has a first cross member and a second cross member extending transversely to the first longitudinal member and the second longitudinal member, wherein the first cross member and the second cross member are each fastened in a material-bonding manner, force-locked manner, or both, to the first longitudinal member and to the second longitudinal member.

14. The chassis arrangement according to claim 8, wherein the chassis arrangement comprises a vehicle component and a fastening means, wherein the fastening means is guided through the fastening opening in the cylinder cover surface of the connection adapter and a further fastening opening of the vehicle component and is fixed to the connection adapter in order to fasten the connection adapter at the vehicle component.

15. A method for producing a connection adapter for fastening a chassis component at a vehicle component, the method comprising:
providing a semi-finished product made of steel;
deep drawing the semi-finished product made of steel in order to obtain a cylindrical region with a cylinder cover surface and a cylinder lateral surface;
introducing a fastening opening into the cylinder cover surface in order to obtain the connection adapter formed as a hollow cylindrical sleeve, which has the cylinder cover surface and the cylinder lateral surface, wherein the cylinder cover surface and the cylinder lateral surface delimit a sleeve interior of the hollow cylindrical sleeve, and wherein the hollow cylindrical sleeve is formed as a one-piece and material-uniform deep-drawn component made of steel.

16. The method according to claim 15, further comprising:
separating a projection extending from the cylinder lateral surface of the connection adapter formed as a hollow cylindrical sleeve.
